(19) United States
(12) Patent Application Publication
(10) Pub. No.: US 2002/0069151 A1
(43) Pub. Date: Jun. 6, 2002

(54) Internet real estate auction with buyer pre-approval method

(76) Inventor: Gary B. Casper, Odessa, FL (US)

Correspondence Address: Paul S. Rooy, 2620 S. Peninsula Dr, Daytona Beach, FL, 32118, US

(21) Appl. No.: 09/728,157

(22) Filed: Dec. 1, 2000

(51) Int. Cl. G06F 17/60

(52) U.S. Cl. 705/37; 705/26; 705/27; 705/38

(57) ABSTRACT

An internet real estate auction with buyer pre-approval method. For a fee, sellers post listings on an auction web site. Buyers brows the listings, and apply for loan pre-approval from lenders. Lenders pre-approve buyers and issue them passwords, so that the buyers can bid on listed properties. Bids are transmitted from the buyers to the sellers through the auction web site. If a seller wishes to accept a bid, he transmits his acceptance to the buyer through the auction web site. The buyer answers with a confirmation, downloads a sales contract, executes the sales contract, and delivers the executed sales contract along with a deposit to an escrow agent. An escrow agent real estate attorney reviews the sales contract, makes any necessary changes, and sends the final sales contract to the buyer and seller for execution. The auction web site operator may provide additional fee-based services such as the provision of signage, lockboxes, and/or pictures to the seller to aid in the sale of the seller's property.

### BACKGROUND OF THE INVENTION

1. Field of the Invention

This invention relates to methods of selling real estate, and in particular to an internet real estate auction with buyer pre-approval method.

2. Background of the Invention

Traditionally, real estate is sold through a broker, who charges a commission from the seller for his services. This commission may be as high as 6-7% of the sale price of the property, which can amount to a fair sum if the sale value of the property is high. In exchange for his commission, the broker generally advertises the property, and shows the property to buyers. Buyers typically tour available properties, decide which property to make an offer on, find out if the offer has been accepted, and only then will the buyer approach a lender for loan approval.

There are a number of problems associated with the above described method of alienating real estate. One problem is the cost contribution of the broker's commission mentioned above.

Another problem is the time wasted all around if the buyer's loan application is not approved. Typical real estate sales contracts provide an escape clause which renders them void if the buyer is unable to obtain financing for the property which is the subject of the sales contract. In such event, the seller is generally required to return the buyer's deposit and start from square one again with a new buyer. In the meantime, the seller has withdrawn the property from the market pending the buyer's loan approval. A lender may take several weeks to analyze a buyer's loan application, obtain necessary credit reports and credit/employment confirmations, and transmit a loan commitment to the buyer. If the answer is negative, the seller has lost valuable time holding the property off the market during the loan decision process. Thus, it would be desirable to provide a real estate auction method wherein only pre-approved buyers may bid.

### SUMMARY OF THE INVENTION

Accordingly, it is an object of the present invention to provide an internet real estate auction with buyer pre-approval method which permits only pre-approved buyers from bidding on listed properties. Design features allowing this object to be accomplished include the method steps of buyer pre-approval by one or more lenders, and a buyer password required for a buyer to place a bid. Advantages associated with the accomplishment of this object include saving the seller's time by providing only bids by pre-approved buyers, and saving the buyer's time by allowing the buyer to place bids in amounts for which a lender has pre-approved credit for that buyer.

It is another object of the present invention to provide a internet real estate auction with buyer pre-approval method which eliminates the need for a third party broker. Design features allowing this object to be accomplished include the method steps of buyers placing bids with sellers through an auction web site, sellers communicating acceptance of such bids to the appropriate buyer(s) through the auction web site, buyers sending confirmation to sellers through the auction web site, and buyers downloading sales contracts from the auction web site, completing same, and delivering same to an escrow agent along with an appropriate deposit. Benefits associated with the accomplishment of this object include time and cost savings by sellers and buyers alike.

It is yet another object of this invention to provide an internet real estate auction with buyer pre-approval method which uses existing infrastructure to achieve its objects. Design features allowing this object to be achieved include the use of the internet and an internet auction web site in order to conduct the instant method buyer pre-approval and auction steps. Benefits associated with reaching this objective include increased availability and reduced cost.

### BRIEF DESCRIPTION OF THE DRAWINGS

The invention, together with the other objects, features, aspects and advantages thereof will be more clearly understood from the following in conjunction with the accompanying drawings.

Two sheets of drawings are provided. Sheet one contains FIGS. 1 and 2. Sheet two contains FIG. 3.

FIG. 1 is a diagrammatic view of a seller registering one or more listings with an auction web site, and paying the appropriate fee.

FIG. 2 is a diagrammatic view of a buyer browsing the auction web site and securing pre-approval with a lender in order to be able to bid on properties listed at the auction web site.

FIG. 3 is a diagrammatic view of the auction mechanism.

### DETAILED DESCRIPTION OF THE PREFERRED EMBODIMENT

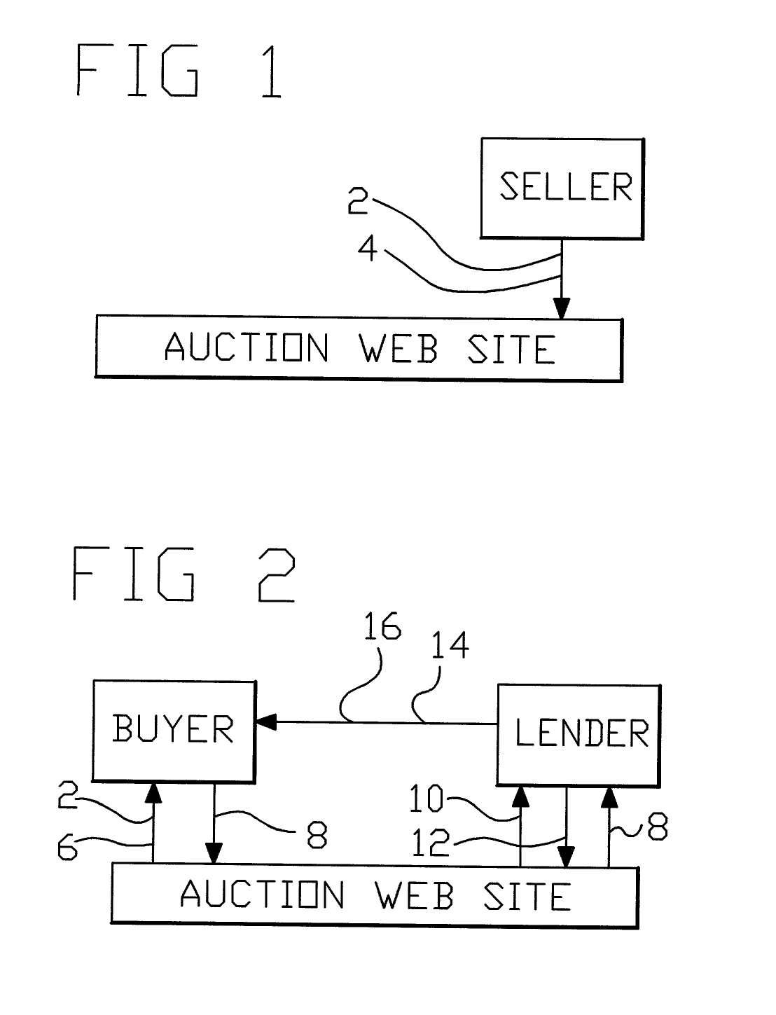

Referring now to FIG. 1 we observe a diagrammatic view of a seller registering one or more property listings with an auction web site. This is accomplished by the seller establishing an internet connection with the auction web site, and sending listing information 2 and the appropriate fee 4 to the auction web site. A typical listing might run for thirty days, for a fixed fee 4. The listing information 2 sent to the auction web site includes the type of information a buyer would typically be interested in when acquainting himself with a property, including pictures.

FIG. 1 shows only one seller posting listing information 2 with the auction web site; in practice, many sellers do so in order to provide a wide variety of property listings for buyers to browse. FIGS. 1-3 show only one buyer; in practice many buyers access the auction web site.

Once fee 4 has been received at the auction web site, and listing information 2 has been posted, prospective buyers may browse the listings freely. In order to bid on any property, however, a buyer must be pre-approved and have a lender-issued buyer password 16. Buyer password 16 is received by a buyer upon his pre-approval, and is required by the auction web site for a buyer to place a bid.

FIG. 2 is a diagrammatic view of a buyer browsing the auction web site and securing buyer pre-approval 14 from a lender in order to be able to bid on properties listed at the auction web site. A buyer secures pre-approval by accessing blank questionnaire 6 from the auction web site, and completing same. Although for clarity only one lender is depicted in FIG. 2, in practice a number of lenders have a presence on the auction web site, each having one or more blank questionnaires 6 available for buyers to complete. Completed questionnaire 8 is received at the auction web site, and a notice of completed questionnaire 10 is sent to the appropriate lender.

The security of the buyer information contained in completed questionnaire 8 is protected by requiring a lender password 12 to access same. Each lender registered with the auction web site has its own lender password 12, which is required for each vendor to access the completed questionnaires 8 submitted for approval.

The lender analyzes the information contained in completed questionnaire 8, obtains any other information (such as credit reports, confirmation of employment/credit references, etc.) required to reach a pre-approval decision, and if appropriate communicates buyer pre-approval 14 to the buyer. Buyer pre-approval 14 contains a loan approval for the buyer, as well as the maximum amount the lender is willing to loan. In addition, the lender supplies a buyer password 16 to the buyer, so that the buyer may bid on properties listed on the auction web site.

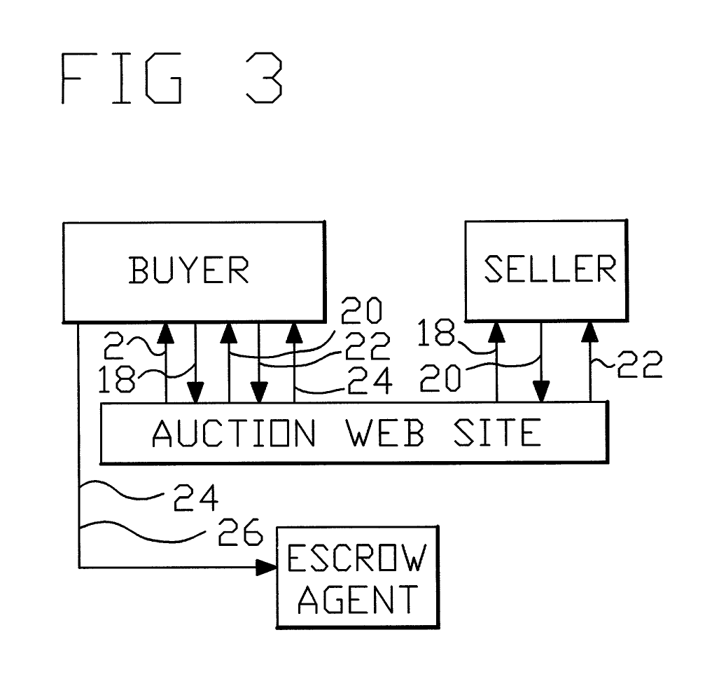

FIG. 3 is a diagrammatic view of the auction mechanism. Upon discovering a property for which a pre-approved buyer wishes to bid, the pre-approved buyer submits bid 18 to the auction web site, who notifies the appropriate seller of bid 18. At his discretion, the seller may accept bid 18 by means of acceptance 20, which is forwarded to the buyer. The buyer sends confirmation 22 to the seller through the auction web site, upon which action bid 18 and acceptance 20 are confirmed.

The buyer may then download an appropriate sales contract 24 from the auction web site, complete and execute same, and submit the executed sales contract 24, along with an appropriate deposit 26, to an escrow agent such as a title company. A real estate attorney at the escrow agent reviews sales contract 24, makes any changes necessary, coordinating such changes with the buyer and seller, and sends the final sales contract to the buyer and seller for execution, upon which execution the auction cycle is complete.

For additional fees, the auction web site operator may provide the seller with one or more signs, lockboxes, and/or pictures, to aid in the advertising and sale of the seller's property.

In summary, the instant internet real estate auction with buyer pre-approval method comprises the steps of:

A. One or more seller listing, for a set period of time, one or more real estate offerings which may include at least one picture, at an auction web site in exchange for a fee paid by the one or more sellers to an auction web site operator;

B. One or more prospective buyers applying for pre-approval by filling out one or more questionnaires located on the auction web site, at least one questionnaire being provided by each lender;

C. The auction web site operator e-mailing a notice of completed questionnaire to each lender for whom a prospective buyer has filled out a pre-approval questionnaire;

D. Each notified lender accessing applicant buyer information at the auction web site using a lender password, and also accessing such information as is necessary to reach a pre-approval decision for that buyer;

E. Each notified lender deciding whether to pre-approve each applicant buyer, and if yes, to what credit limit, and notifying each applicant buyer of such pre-approval decision, and issuing a buyer password to each pre-approved prospective buyer;

F. The one or more pre-approved buyers browsing the real estate offerings listed on the auction web site;

G. Using the buyer password issued, the one or more pre-approved buyers placing one or more bids through the auction web site to buy one or more properties listed there;

H. An appropriate seller accepting, at such seller's discretion, a bid pertaining to a property offered for sale by such seller; and

I. A buyer confirming such bid and acceptance via e-mail, and providing an earnest money deposit and real estate sales contract to an appropriate escrow agent, such as a title company, within a fixed period of time.

The following optional method steps may be added:

J. The appropriate seller may notify the appropriate buyer of that seller's acceptance of that buyer's bid by e-mail.

K. For a fee paid by a seller to the auction web site operator, the auction web site operator may provide signage advertising that seller's property sale.

L. For a fee paid by a seller to the auction web site operator, the auction web site operator may provide one or more pictures of the seller's property which is for sale, so as to help the seller sell his property.

M. For a fee paid by a seller to the auction web site operator, the auction web site operator may provide one or more lockboxes to aid in that seller's property sale.

N. The buyer may download a sales contract to complete and execute for delivery to the escrow agent.

While a preferred embodiment of the invention has been illustrated herein, it is to be understood that changes and variations may be made by those skilled in the art without departing from the spirit of the appending claims.

### DRAWING ITEM INDEX

2 listing information

4 fee

6 blank questionnaire

8 completed questionnaire

10 notice of completed questionnaire

12 lender password

14 buyer pre-approval

16 buyer password

18 bid

20 acceptance

22 confirmation

24 sales contract

26 deposit

I claim:

1. An internet real estate auction with buyer pre-approval method comprising the steps of:
A. One or more seller listing, for a set period of time, one or more real estate offerings which may include at least one picture, at an auction web site in exchange for a fee paid by the one or more sellers to an auction web site operator;
B. One or more prospective buyers applying for pre-approval by filling out one or more pre-approval questionnaires located on said auction web site, at least one said questionnaire being provided by each of one or more lenders;
C. Said auction web site operator sending a notice of completed questionnaire to each said lender for whom a prospective said buyer has filled out at least one said pre-approval questionnaire;
D. Each of the notified lenders accessing applicant buyer information at said auction web site using a lender password, and also accessing such information as is necessary to reach a pre-approval decision for that said buyer;
E. Each said notified lender deciding whether to pre-approve each said applicant buyer, and if affirmative, to what credit limit, and notifying each said applicant buyer of such pre-approval decision, and issuing a buyer password to each pre-approved prospective said buyer;
F. One or more said pre-approved buyers browsing said real estate offerings listed on said auction web site;
G. Using said buyer password issued, said one or more pre-approved buyers placing one or more bids through said auction web site to buy one or more properties listed there;
H. An appropriate said seller accepting, at such said seller's discretion, a bid pertaining to one said property offered for sale by such seller; and
I. Said buyer confirming such bid and acceptance, and providing an earnest money deposit and real estate sales contract to an appropriate escrow agent, such as a title company, within a fixed period of time.

2. The method of claim 1 comprising the further step of:
J. Said one or more pre-approved buyers placing one or more bids through said auction web site via e-mail, and the appropriate said seller notifying an appropriate said buyer of said seller's acceptance of said buyer's bid by e-mail.

3. The method of claim 1 comprising the further step of:
K. For a fee paid by one said seller to said auction web site operator, said auction web site operator providing signage advertising said seller's property sale.

4. The method of claim 1 comprising the further step of:
L. For a fee paid by one said seller to said auction web site operator, said auction web site operator providing one or more pictures of said seller's property which is for sale, so as to help said seller sell his property.

5. The method of claim 1 comprising the further step of:
M. For a fee paid by said seller to said auction web site operator, said auction web site operator providing one or more lockboxes to aid in said seller's property sale.

6. The method of claim 1 comprising the further step of:
N. Said buyer downloading a sales contract to complete and execute for delivery to said escrow agent.
